(19) United States
(12) Patent Application Publication
(10) Pub. No.: US 2026/0022929 A1
(43) Pub. Date: Jan. 22, 2026

(54) METAL RECESS DEPTH MEASUREMENTS BY CAPACITOR TEST STRUCTURE

(71) Applicant: Tokyo Electron Limited, Tokyo (JP)

(72) Inventors: Partha MUKHOPADHYAY, Oviedo, FL (US); Henry Jim FULFORD, Marianna, FL (US); Mark I. GARDNER, Austin, TX (US)

(21) Appl. No.: 18/780,344

(22) Filed: Jul. 22, 2024

(51) Int. Cl. G01B 7/26

(52) U.S. Cl. CPC G01B 7/26

(57) ABSTRACT

A system for testing metal recess depths into a wafer includes a test structure formed in the wafer, and probe pads positioned vertically over the test structure. The test structure includes a first region and a second region laterally adjacent to each other. The first region includes a dielectric layer having a top surface and a metal layer formed under the top surface. The second region includes the dielectric layer, the metal layer, and a first metal pad and a second metal pad laterally separated, vertically extend into the dielectric layer from the top surface, and in contact with the metal layer. The probe pads include a first and a second probe pads configured to be vertically over the first region, and a third and a fourth probe pads configured to be vertically over the second region and to align with the first and the second metal pads, respectively.

### TECHNICAL FIELD

The present application generally relates to the field of testing semiconductor wafers.

### BACKGROUND

The semiconductor industry has experienced rapid growth due to ongoing improvements in the integration density of a variety of electronic components (e.g., transistors, diodes, resistors, capacitors, etc.). For the most part, improvement in integration density has resulted from iterative reduction of minimum feature size, which allows more components to be integrated into a given area. In semiconductor manufacturing, for instance, etching, deposition, and Chemical-Mechanical Polishing (CMP) processes are used for forming metal (e.g., copper Cu) pads into a die or a wafer, and due to various reasons, metal recesses (e.g., Cu recesses) with various depths may occur after these processes are completed, and thus may impact the product performance, such as the face to face bonding between two wafers or a die and a wafer. Thus, non-destructive and in-situ techniques to measure the metal recess depths is highly demanded in order to determine how to deal with these metal recesses.

### SUMMARY

In an aspect, a system for testing metal recess depths into a wafer may include a test structure formed in the wafer and including a first region and a second region laterally adjacent to each other. The first region includes a dielectric layer having a top surface, and a metal layer formed vertically under the top surface. The second region includes the dielectric layer, the metal layer formed vertically under the top surface, and a first metal pad and a second metal pad laterally separated from each other, vertically extending into the dielectric layer from the top surface, and being in contact with the metal layer. The system also includes probe pads positioned vertically over the test structure. The probe pads include a first probe pad and a second probe pad vertically over and directed to the first region, and a third probe pad (5A) and a fourth probe pad vertically over the second region and respectively directed to the first metal pad and the second metal pad.

In another aspect, a test structure includes a dielectric layer formed in the wafer, a metal layer formed in the dielectric layer and vertically under a top surface thereof, and a first region and a second region formed laterally adjacent to each other. The first region includes the dielectric layer, and the metal layer. The second region includes the dielectric layer, the metal layer, and a first metal pad and a second metal pad laterally separated from each other, vertically extending into the dielectric layer from the top surface, and being in contact with the metal layer.

In yet another aspect, a method of measuring a recess depth of a metal pad into a wafer is provided. The method includes: forming a test structure including a first region and a second region adjacent to each other in a wafer, in which the first region includes a dielectric layer and a metal layer, and in which the second region includes the dielectric layer, the metal layer, and a first metal pad and a second metal pad that laterally separated from each other, vertically extend into the dielectric layer, and contact the metal layer; placing probe pads vertically adjacent to the test structure, in which the probe pads comprise a first probe pad and a second probe pad vertically over the first region, and a third probe pad and a fourth probe pad vertically over the first metal pad and the second metal pad respectively in the second region; forming form a first capacitor and a second capacitor coupled in series by the first probe pad and the second probe pad, the metal layer, and a first air gap and the dielectric layer therebetween; forming a third capacitor and a fourth capacitor coupled in series by the third probe pad and the fourth probe pad, the metal layer, and a second air gap therebetween; measuring capacitance values of the first, the second, the third, and the fourth capacitors by a capacitance measuring device coupled to the probe pads; and calculating a recess depth of the first metal pad from the top surface of the dielectric layer as a function of the capacitance values of the first, the second, the third, and the fourth capacitors.

Implementations of the described techniques may include hardware, a method or process, or a computer tangible medium for performing the process.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic view of a system including probe pads and a testing structure formed in a wafer capable of testing depths of metal recesses into the wafer according to some embodiments.

FIG. 2 is a schematic view of the system as shown in FIG. 1 while the probe pads and the testing structure are positioned for testing the depths of the metal recesses into the wafer, according to some embodiments.

FIG. 3 is a top view of the system as shown in FIG. 1, according to some embodiments.

FIG. 4 is a schematic view of the system as shown in FIG. 1 in which an area of a probe pad is larger than an area of a metal pad, according to some embodiments.

FIG. 5 is a schematic view of the system different from the system as shown in FIG. 4 in which an area of a probe pad is smaller than an area of a metal pad, according to some embodiments.

FIG. 6 is a flowchart illustrating a method for testing depths of metal recesses into a wafer, according to some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact. There are also embodiments in which additional features may be formed between the first and second features such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element or feature as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In semiconductor manufacturing, for instance, etching, deposition, and Chemical-Mechanical Polishing (CMP) processes are used for forming metal (e.g., copper Cu) pads into a die or a wafer, and due to various reasons, metal (e.g., Cu) recesses with various depths may occur after these processes, and thus may impact product performance, such as face-to-face bonding between two wafers. There are challenges in finding suitable ways to measure metal recess depths, for example, techniques of using spectroscopy are time consuming and expensive. Non-destructive and in-situ techniques to measure metal recess depth are highly demanded.

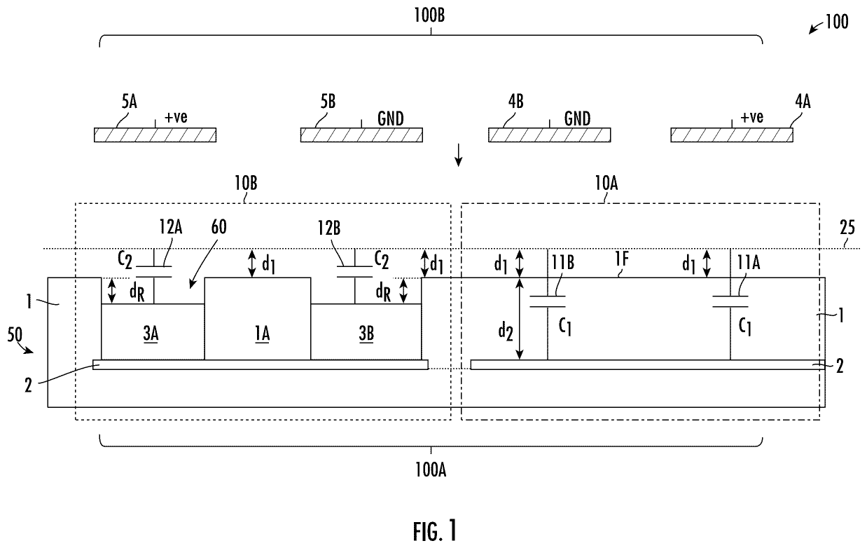

FIG. 1 is a schematic view of a system 100 including a testing structure 100A formed in a wafer 50 and probe pads 100B capable of testing depths d_{R} of metal recesses 60 into the wafer according to some embodiments. In some embodiments, the test structure 100A includes a first region 10A and a second region 10B that are laterally adjacent to and separated from each other. In some embodiments, the first metal pad 3A and the second metal pad 3B are laterally separated from each other. In some embodiments, the first region 10A includes a dielectric layer 1 with a top surface 1F, and a metal layer or rail 2 formed vertically under the top surface 1F of the dielectric layer 1. The second region 10B includes the dielectric layer 1, the metal layer 2 formed vertically under the top surface 1F of the dielectric layer 1, and a first metal pad 3A and a second metal pad 3B, which are laterally separated from each other by a portion 1A of the dielectric layer 1, vertically extend into the dielectric layer 1 from the top surface 1F of the dielectric layer 1, and are in contact with the metal layer 2.

In some embodiments, the probe pads 100B are positioned vertically over the test structure 100A. In some embodiments, the probe pads 100B are parts of a capacitance measurement device (not shown). In some embodiments, the probe pads 100B include a first probe pad 4A and a second probe pad 4B that are placed over the first region 10A, and a third probe pad 5A and a fourth probe pad 5B that are placed directly over the first metal pad 3A and the second metal pad 3B in the second region 10B, respectively. In some embodiments, the probe pads 100B have bottom surfaces that are on the same level and are configured to move together downwardly to a predetermined position or level 25 adjacent to the top surface 1F of the dielectric layer 1 to test recess depths d_{R} of the first metal pad 3A and the second metal pad 3B into the wafer 50. In some embodiments, the recess depths d_{R} of the first metal pad 3A and the second metal pad 3B are identical.

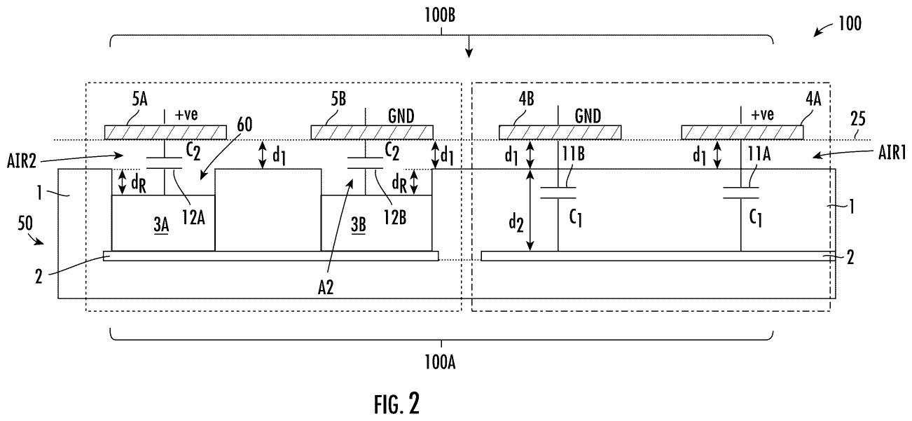

FIG. 2 is a schematic view of the system 100 as shown in FIG. 1 while the probe pads 100B and the testing structure 100A are at on predetermined position for testing the depths d_{R} of the metal recesses 60 into the wafer 50 according to some embodiments. As shown in FIG. 2, upon the probe pads 100B being moved downwardly to the predetermined position or level 25 adjacent to the top surface 1F of the dielectric layer 1, a first capacitor 11A (C1) and a second capacitor 11B (C2) coupled in series are formed by the first probe pad 4A and the second probe pad 4B, the metal layer 2, and a first air gap AIR₁ and a portion of the dielectric layer 1 therebetween; a third capacitor 12A is formed by the third probe pad 5A, the first metal pad 3A, and a second air gap AIR₂ therebetween; and a fourth capacitor 12B is formed by the fourth probe pad 5B, the second metal pad 3B, and a second air gap AIR₂ therebetween, the fourth capacitor 12B being coupled to the third capacitor 12A in series.

In some embodiments, during testing, the first probe pad 4A is coupled to a first positive voltage (+ve) and the second probe pad (4B) is grounded, while the third probe pad 5A is coupled to a second positive voltage (+ve) and the fourth probe pad 5B is grounded. In some embodiments, all of the probe pads are coupled to a capacitance measurement device (not shown). As such, a first capacitance value (C_{dielectric} or C_{die}) of the first capacitor 11A and the second capacitor 11B in series can be measured by the capacitance measurement device, and a second capacitance value (C_{recess} or C_{rec}) of the third capacitor 12A and the fourth capacitor 12B in series can also be measured by the capacitance measurement device. In some embodiments, a capacitance difference value M of the second capacitance value (C_{recess}) and the first capacitance value (C_{dielectric}) can be measured by the capacitance measurement device. Here, M=C_{dielectric}−C_{recess}. The capacitance difference value M can be used to calculate the recess depth d_{R} of recesses 60 of the first metal pad 3A and the second metal pad 3B, which will be explained below.

Referring to FIG. 2, a first distance d₁ is defined as a distance from the top surface 1F of the dielectric layer 1 to bottom surfaces of the probe pads 100B that are on an identical level 25 at a predetermined position 25; a second distance d₂ is defined as a distance from a top surface of the metal layer 2 to the top surface 1F of the dielectric layer 1; and a recess depth d_{R} of a recess 60 of the first metal pad 3A and the second metal pad 3B is defined as a distance from the top surface 1F of the dielectric layer 1 to top surfaces of the first metal pad 3A and the second metal pad 3B that are on the same level. In some embodiments, the first distance d₁ and the second distance d₂ are predetermined and thus known before the testing. In some embodiments, the first distance d₁ is zero (that is d₁=0). In other embodiments, the first distance d₁ and the second distance d₂ are measured, for example, by an ellipsometer (not shown) prior to the capacitance measurement. In some embodiments, a dielectric constant of the air gap (AIR₁) between prob pads 11A/11B and the dielectric layer 1 or the air gap (AIR₂) between prob pads 12A/12B and the metal pads 3A/3B is known prior to the capacitance measurement, and a dielectric constant of the dielectric layer 1 is also known prior to the capacitance measurement.

In some embodiments, the recess depth d_{R} of the first metal pad 3A and the second metal pad 3B is calculated as a function of the capacitance values of the first capacitor 11A, the second capacitor 11B, the third capacitor 12A, and the fourth capacitor 12B, a dielectric constant of the air gap AIR₁/AIR₂, and a dielectric constant of the dielectric layer 1. Some formulas are shown below for example, in which A is an area of each of the first metal pad 3A and the second metal pad 3B. Merely for simplicity purpose, in the following formulas, an area of each of the probe pads (such as 4A, 4B, 5A and 5B) is supposed to be the same as the area A of each of the first metal pad 3A and the second metal pad 3B. In some embodiments, supposed that d₁, d₂, is a function of M, herein M is a capacitance difference value of the second capacitance value (C_{recess}) and the first capacitance value (C_{dielectric}), which can be measured by the capacitance measurement device (not shown).

$${C}_{1} = \frac{{ϵ}_{1} {ϵ}_{2} A}{{ϵ}_{1} {d}_{2} + {ϵ}_{2} {{d}_{1}}_{`}}$$

$${C}_{Dielectric} = \frac{{C}_{1}}{2} = \frac{{ϵ}_{1} {ϵ}_{2} A}{2 ( {ϵ}_{1} {d}_{2} + {ϵ}_{2} {d}_{1} )} \to {d}_{1} = \frac{{ϵ}_{1} A}{2 {C}_{Die}} - \frac{{ϵ}_{1} {d}_{2}}{{ϵ}_{2}}$$

$${C}_{2} = \frac{{ϵ}_{1} A}{{d}_{1} + {d}_{R}}$$

$${C}_{Recess} = \frac{{C}_{2}}{2} = \frac{{ϵ}_{1} A}{2 ( {d}_{1} + {d}_{R} )} \to {d}_{1} = \frac{{ϵ}_{1} A}{2 {C}_{Rec}} - {d}_{R}$$

$$\begin{matrix}{d}_{1} = \frac{{ϵ}_{1} A}{2 {C}_{Rec}} - {d}_{R} \\ = \frac{{ϵ}_{1} A}{2 {C}_{Die}} - \frac{{ϵ}_{1} {d}_{2}}{{ϵ}_{2}} \to {d}_{R} \\ = \frac{{ϵ}_{1} A}{2 {C}_{Rec}} - \frac{{ϵ}_{1} A}{2 {C}_{Die}} + \frac{{ϵ}_{1} {d}_{2}}{{ϵ}_{2}} \to {d}_{R} \\ = \frac{{ϵ}_{1} A}{2 {C}_{Rec}} - \frac{{ϵ}_{1} A}{2 {C}_{Die}} + \frac{{ϵ}_{1} {d}_{2}}{{ϵ}_{2}} \to {d}_{R} \\ = \frac{{ϵ}_{1} A}{2} ( \frac{1}{{C}_{Rec}} - \frac{1}{{C}_{Die}} ) + \frac{{ϵ}_{1} {d}_{2}}{{ϵ}_{2}} \to {C}_{Recess} - {C}_{Dielectric} \\ = Mean ( M ) \\ = \frac{{C}_{1} - {C}_{2}}{2} \\ = \frac{{ϵ}_{1} A}{2 ( {d}_{1} + {d}_{R} )} - \frac{{ϵ}_{1} {ϵ}_{2} A}{2 ( {ϵ}_{1} {d}_{2} + {ϵ}_{2} {d}_{1} )} \to {d}_{R} \\ = \vert \frac{1}{\frac{2 M}{{ϵ}_{1} A} + \frac{{ϵ}_{2}}{{ϵ}_{1} {d}_{2} + {ϵ}_{2} {d}_{1}}} \vert - {d}_{1}\end{matrix}$$

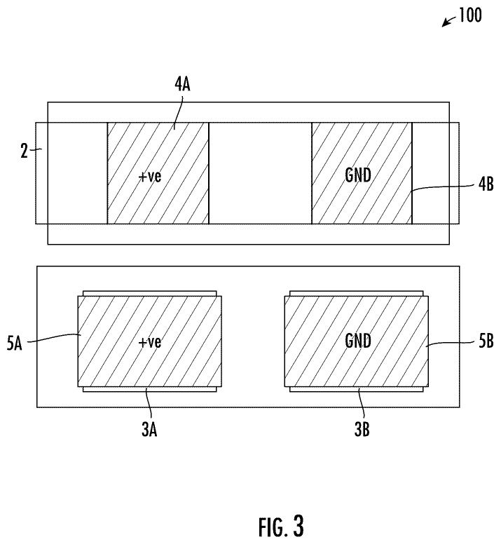

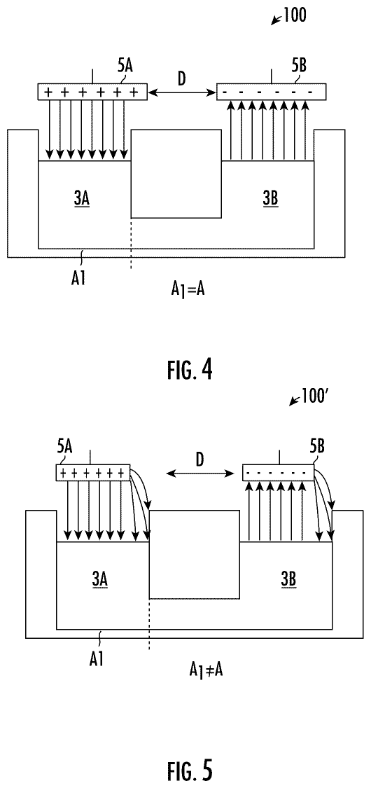

FIG. 3 is a top view of the system 100 as shown in FIG. 1 according to some embodiments. In some embodiments, an area of the first metal pad 3A and an area of the second metal pad 3B are identical to be A, and an area of each of the probe pads 5A and 5B is larger than the area A of each of the first metal pad 3A and the second metal pad 3B. FIG. 4 is a schematic view of the system 100 as shown in FIG. 1 in which an area of a probe pad (e.g., 5A) is larger than an area of a metal pad (e.g., 3A) according to some embodiments. With larger prob pad area, the electromagnetic field created by the probe pad (e.g., 5A) can always see the whole metal pad (e.g., 3A), and thus can advantageously keep the effective area (e.g., A) constant for calculating capacitance. In this case, area A in the formulars as shown above=area A1 of a metal pad (e.g., 3A). FIG. 5 is a schematic view of another system 100′ different from the system 100 as shown in FIG. 4, in which an area of a probe pad (e.g., 5A) is smaller than an area A1 of a metal pad (e.g., 3A). Instead, with a smaller prob pad area, the electromagnetic field created by the probe pad (e.g., 5A) cannot see the whole metal pad (e.g., 3A), and thus the effective area for calculating capacitance can be variable, and thus the area A1 of a metal pad (e.g., 3A) does not equal to (or does not qualify as) the area A in the formulars, thereby leading to an accurate capacitance calculation. Thus, according to some embodiments of the present application, an area of each of the probe pads 5A and 5B is larger than the area A of each of the first metal pad 3A and the second metal pad 3B. In addition, as shown in e.g., FIG. 4, the probe pads 5A and 5B are separated from each other by a distance D that is greater than a predetermined distance to avoid crosstalk between them.

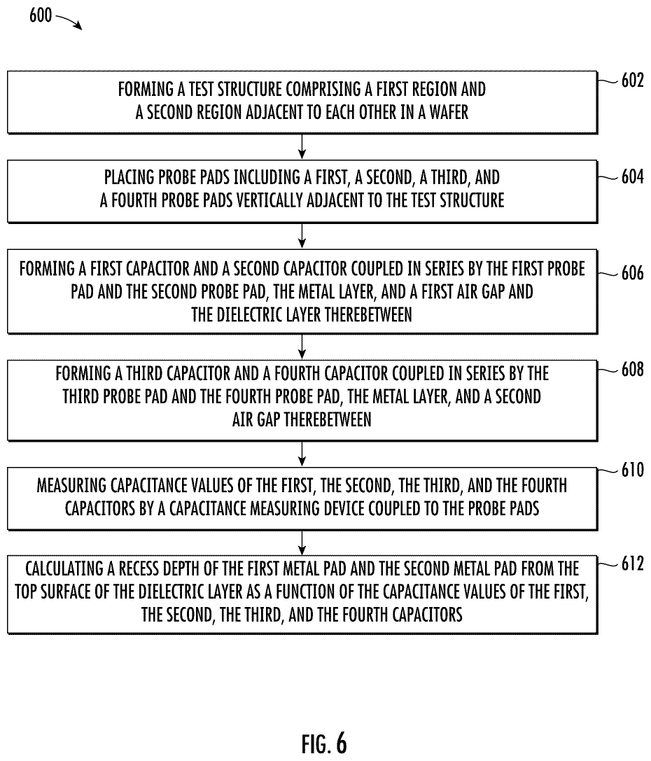

FIG. 6 is a flowchart illustrating a method 600 for testing depths of metal recesses 60 into a wafer 50 according to some embodiments. It should be noted that the method 600 is merely an example, and is not intended to limit the present disclosure. Accordingly, it is understood that the order of operation of the method 600 of FIG. 6 can change, that additional operations may be provided before, during, and after the method 600 of FIG. 6, and that some other operations may only be described briefly herein.

Referring to FIGS. 1 and 6, the method 600 starts with operation 602 of receiving a test structure 100A that includes a first region 10A and a second region 10B adjacent to each other in a wafer 50. In some embodiments, as shown in FIG. 1, the first region 10A includes a dielectric layer 1 and a metal layer 2, and the second region 10B includes the dielectric layer 1, the metal layer 2, and a first metal pad 3A and a second metal pad 3B that are laterally separated from each other by a portion 1A of the dielectric layer 1, vertically extend into the dielectric layer 1, and are in contact with the metal layer 2.

Next, referring to FIGS. 2 and 6, the method 600 proceeds to operation 604 of placing probe pads 100B vertically adjacent to the test structure 100A on a predetermined position 25. In some embodiments, the probe pads 100B include a first probe pad 4A and a second probe pad 4B vertically over the first region 10A, and a third probe pad 5A and a fourth probe pad 5B directly over the first metal pad 3A and the second metal pad 3B respectively in the second region 10B, respectively. In some embodiments, the third probe pad 5A and the fourth probe pad 5B are separated from each other by a distance D that is greater than a predetermined distance to reduce or avoid crosstalk between them. In some embodiments, an area of each of the probe pads 5A and 5B is larger than the area A of each of the first metal pad 3A and the second metal pad 3B for an accurate measurement of capacitance considering the electromagnetic field distribution between two metal pads. As such, dependency of alignment between the probe pads 5A/5B and the metal pads 3A/3B can be avoided.

Next, referring to FIGS. 2 and 6, the method 600 proceeds to operation 606 of forming a first capacitor 11A (C₁) and a second capacitor 11B (C₁), which are coupled in series, by the first probe pad 4A and the second probe pad 4B, the metal layer 2, and a first air gap AIR₁ and the dielectric layer 1 therebetween.

Next, referring to FIGS. 2 and 6, the method 600 proceeds to operation 608 of forming a third capacitor 12A and a fourth capacitor 12B, which are coupled in series, by the third probe pad 5A and the fourth probe pad 5B, the metal layer 2, and a second air gap AIR₂ therebetween.

Next, referring to FIG. 6, the method 600 proceeds to operation 610 of measuring capacitance values of the first, the second, the third, and the fourth capacitors (11A, 11B, 12A, and 12B) by a capacitance measuring device (not shown) that is coupled to the probe pads 100B (including 4A, 4B, 5A and 5B). In some embodiments, while testing, the first probe pad 4A is coupled to a first positive voltage (+ve) and the second probe pad 4B is grounded, and the third probe pad 5A is coupled to a second positive voltage (+ve) and the fourth probe pad 5B is grounded.

Next, referring to FIG. 6, the method 600 proceeds to operation 612 of calculating a recess depth d_{R} of the first metal pad 3A and the second metal pad 3B from the top surface 1F of the dielectric layer 1 into the wafer 50 as a function of the capacitance values of the first capacitor 11A, the second capacitor 11B, the third capacitor 12A, and the fourth capacitor 12B.

In some embodiments, as recited above, the recess depth d_{R} of the first metal pad 3A and the second metal pad 3B is calculated as a function of the capacitance values of the first capacitor 11A, the second capacitor 11B, the third capacitor 12A, and the fourth capacitor 12B, and a first distance d₁ that is measured from the top surface 1F of the dielectric layer 1 to bottom surfaces (having an identical level) of the probe pads 100B prior to the capacitance measurement.

In some embodiments, as recited above, the recess depth d_{R} of the first metal pad 3A and the second metal pad 3B is calculated as a function of the capacitance values of the first capacitor 11A, the second capacitor 11B, the third capacitor 12A, and the fourth capacitor 12B, and a second distance d₂ that is measured from a top surface of the metal layer 2 to the top surface 1F of the dielectric layer 1 prior to the capacitance measurement.

In some embodiments, as recited above, the recess depth d_{R} of the first metal pad 3A and the second metal pad 3B is calculated as a function of the capacitance values of the first, the second, the third, and the fourth capacitors (11A-12B), a first dielectric constant of the air of the air gap, and a second dielectric constant of the dielectric layer 1.

In some embodiments, working together with the test structure 100A having the metal rail 2 buried in the dielectric layer 1, the probe pads 100B (of a capacitance measurement device not shown) can measure a capacitance difference value M between the second capacitance value (C_{recess}) and the first capacitance value (C_{dielectric}), and thus can calculate the recess depth d_{R} of the first metal pad 3A and the second metal pad 3B as a function of the capacitance difference value M.

As such, according to the various embodiments of the present application, with the test structure 100A having the metal rail 2 buried in the dielectric layer 1 and the probe pads 100B, the recess depth d_{R} of the first metal pad 3A and the second metal pad 3B into the wafer 50 can advantageously be calculated based on the capacitance measurement in a non-destructive, inexpensive, and time-saving way, thereby leading to improved product performance.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims 1-20 and their equivalents, in which all terms are meant in their broadest reasonable sense unless otherwise indicated.

What is claimed is:

1. A system for testing metal recess depths into a wafer, comprising:
a test structure formed in the wafer, the test structure comprising a first region and a second region,
wherein the first region comprises:
a dielectric layer having a top surface; and
a metal layer formed vertically under the top surface; and
wherein the second region comprises:
the dielectric layer;
the metal layer formed vertically under the top surface; and
a first metal pad and a second metal pad laterally separated from each other, vertically extending into the dielectric layer from the top surface, and being in contact with the metal layer; and
probe pads positioned vertically over the test structure and comprising:
a first probe pad and a second probe pad configured to vertically align with the first region; and
a third probe pad and a fourth probe pad configured to vertically align with the first metal pad and the second metal pad, respectively.

2. The system of claim 1, wherein upon the probe pads being positioned adjacent to the top surface of the dielectric layer, the first probe pad and the second probe pad, the metal layer, and a first air gap and the dielectric layer therebetween form a first capacitor and a second capacitor coupled in series, and the third probe pad and the fourth probe pad, the metal layer, and a second air gap therebetween form a third capacitor and a fourth capacitor coupled in series.

3. The system of claim 2, wherein the first probe pad is coupled to a first positive voltage and the second probe pad is grounded, and wherein the third probe pad is coupled to a second positive voltage and the fourth probe pad is grounded.

4. The system of claim 2, wherein a first distance is from the top surface of the dielectric layer to bottom surfaces of the probe pads that are on an identical level, and a second distance is from a top surface of the metal layer to the top surface of the dielectric layer.

5. The system of claim 4, wherein the system is configured to calculate a recess depth of the first metal pad and the second metal pad measured from the top surface of the dielectric layer to top surfaces of the first metal pad and the second metal pad based on a first capacitance value of the first capacitor and the second capacitor, a second capacitance value of the third capacitor and the fourth capacitor, and the first distance.

6. The system of claim 4, wherein the system is configured to calculate a recess depth of the first metal pad and the second metal pad measured from the top surface of the dielectric layer to top surfaces of the first metal pad and the second metal pad based on a first capacitance value of the first capacitor and the second capacitor, a second capacitance value of the third capacitor and the fourth capacitor, and the second distance.

7. The system of claim 4, wherein the first distance is equal to 0.

8. The system of claim 2, wherein an area of the first metal pad and an area of the second metal pad are identical, and an area of each of the probe pads is larger than the area of each of the first metal pad and the second metal pad.

9. The system of claim 1, wherein the first metal pad and the second metal pad are laterally separated from each other by a portion of the dielectric layer.

10. A testing apparatus, comprising:
a dielectric layer in the wafer;
a metal layer in the dielectric layer and vertically under a top surface thereof; and
a first region and a second region formed laterally adjacent to each other,
wherein the first region comprises the dielectric layer, and the metal layer, wherein the second region comprises the dielectric layer, the metal layer, and a first metal pad and a second metal pad that are laterally separated from each other by a portion of the dielectric layer, vertically extend into the dielectric layer from the top surface and are in contact with the metal layer, wherein the testing apparatus is configured to work with probe pads to perform a measuring of metal recess depths into the wafer, and wherein the probe pads are positioned vertically over the test structure.

11. The testing apparatus of claim 10, wherein the probe pads comprise a first probe pad and a second probe pad configured to be vertically over the first region, and a third probe pad and a fourth probe pad configured to vertically align with the first metal pad and the second metal pad in the second region, respectively.

12. The testing apparatus of claim 11, wherein upon the probe pads being positioned adjacent to the top surface of the dielectric layer, the first probe pad and the second probe pad, the metal layer, and a first air gap and the dielectric layer therebetween form a first capacitor and a second capacitor coupled in series, and wherein the third probe pad and the fourth probe pad, the metal layer, and a second air gap therebetween form a third capacitor and a fourth capacitor coupled in series.

13. The testing apparatus of claim 12, wherein a recess depth of the first metal pad and the second metal pad from the top surface of the dielectric layer to top surfaces of the first metal pad and the second metal pad is calculated as a function of capacitance values of the first capacitor, the second capacitor, the third capacitor, and the fourth capacitor.

14. A method of measuring a metal pad recess depth, comprising:
receiving a test structure comprising a first region and a second region adjacent to each other in a wafer, wherein the first region comprises a dielectric layer and a metal layer, and wherein the second region comprises the dielectric layer, the metal layer, and a first metal pad and a second metal pad that laterally separated from each other, vertically extend into the dielectric layer, and contact the metal layer;
placing probe pads vertically adjacent to the test structure, wherein the probe pads comprise a first probe pad and a second probe pad vertically over the first region, and a third probe pad and a fourth probe pad vertically aligned with the first metal pad and the second metal pad in the second region, respectively; and
calculating a recess depth of the first metal pad and the second metal pad from a top surface of the dielectric layer into the wafer as a function of capacitance values between the probe pads and the test structure.

15. The method of claim 14, further comprising:
obtaining a first capacitor and a second capacitor coupled in series by the first probe pad and the second probe pad, the metal layer, and a first air gap and the dielectric layer therebetween;
obtaining a third capacitor and a fourth capacitor coupled in series by the third probe pad and the fourth probe pad, the metal layer, and a second air gap therebetween;
obtaining capacitance values of the first, the second, the third, and the fourth capacitors by a capacitance measuring device coupled to the probe pads; and
calculating the recess depth of the first metal pad and the second metal pad from the top surface of the dielectric layer as a function of the capacitance values of the first, the second, the third, and the fourth capacitors.

16. The method of claim 14, wherein the recess depth of the first metal pad and the second metal pad from the top surface of the dielectric layer into the wafer is calculated as a function of the capacitance values of the first, the second, the third, and the fourth capacitors, and a distance from a top surface of the metal layer to the top surface of the dielectric layer.

17. The method of claim 14, wherein the third probe pad and the fourth probe pad are separated from each other by a distance greater than a predetermined distance.

18. The method of claim 16, wherein the recess depth of the first metal pad and the second metal pad is calculated as a function of the capacitance values of the first, the second, the third, and the fourth capacitors, and a first distance measured from the top surface of the dielectric layer to bottom surfaces of the probe pads that are on an identical level.

19. The method of claim 16, wherein the recess depth of the first metal pad and the second metal pad is calculated as a function of the capacitance values of the first, the second, the third, and the fourth capacitors, and a second distance measured from a top surface of the metal layer to the top surface of the dielectric layer.

20. The method of claim 16, wherein the recess depth of the first metal pad and the second metal pad is calculated as a function of the capacitance values of the first, the second, the third, and the fourth capacitors, a dielectric constant of the air, a distance from a top surface of the metal layer to the top surface of the dielectric layer, and a dielectric constant of the dielectric layer.
